(19) United States
(12) Patent Application Publication
(10) Pub. No.: US 2005/0126323 A1
(43) Pub. Date: Jun. 16, 2005

(54) Hypoid geared motor and connection structure between motor pinion and hypoid pinion

(75) Inventors: Takashi Haga, Ohbu-shi (JP); Mitsuhiro Tamura, Ohbu-shi (JP)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Sumitomo Heavy Industries, Ltd.

(21) Appl. No.: 11/009,027

(22) Filed: Dec. 13, 2004

(30) Foreign Application Priority Data
Dec. 16, 2003 (JP) 2003-418588
Feb. 6, 2004 (JP) 2004-030467

(51) Int. Cl. F16H 55/18

(52) U.S. Cl. 74/421 A

(57) ABSTRACT

A motor has a motor shaft with a motor pinion formed on the motor shaft. A hypoid gear box has a hypoid pinion. The hypoid pinion is engageable with an outer circumference of the motor pinion at an end portion of a motor side thereof. A friction clamp is formed on the end portion. The friction clamp connects the hypoid pinion and the motor pinion by friction clamping.

### BACKGROUND OF THE INVENTION

1. Field of the Invention

The present invention relates to a hypoid geared motor, and in particular, to a hypoid geared motor having an advantage in a connection structure between a motor pinion which is formed on a motor shaft and a hypoid pinion.

2. Description of the Related Art

A hypoid gear set comprising a hypoid pinion and a hypoid gear is incorporated into a driving device as a so-called orthogonal transformation mechanism because it can change a direction of a rotating shaft to be at a right angle.

The orthogonal transformation mechanism constituted by the hypoid gear set is advantageous in that a device incorporating the gear set can be downsized. The orthogonal transformation mechanism is also more efficient than a worm gear set having similar functions and can be driven at a lower noise with a smaller vibration as compared with a bevel gear set. In addition, its only one-stage structure can ensure a high reduction ratio. Therefore, there is a strong need for the orthogonal transformation mechanism constituted by the hypoid gear set in a specific field.

On the other hand, in order to respond to production at a small amount for a variety of types in recent years, in each factory or the like such a structure that each machine can be independently driven on the spot is more and more desired so as to satisfy a request for driving a necessary machine only for necessary time. Therefore, there is an increasing need of a so-called “geared motor” constituted by integrally assembling a gear box housing a reduction mechanism therein and a motor so as to obtain an output whose torque and speed of rotation are regulated to be optimal by itself.

For gear boxes used as geared motors, gear mechanisms with parallel axes or bevel gear mechanisms are overwhelmingly dominating in terms of number for the reason of cost. Thus, in response to such a phenomenon, a large number of motors with pinions are shipped. In such a motor with a pinion, a spur pinion or a helical pinion is formed on a motor shaft in advance so that the motor shaft also serves for the functions of the first stage (an input shaft) of a reduction gear.

As described above, in the recent factories, “modification” is frequently carried out to realize the fabrication of various kinds of products at a small amount; for example, the mechanical facilities or the conveyance facilities in a factory are recombined, a torque or conveying speed is changed to be more appropriate, or the like. Therefore, for example, in a machine using a pair gear mechanism with parallel axes up to now, there quite often arises the need of transforming a direction of rotation of an output shaft to a direction at a right angle.

As a geared motor capable of transforming a direction of rotation of an output shaft to a direction at a right angle, for example, a hypoid geared motor as disclosed in Japanese Patent Laid-Open Publication No. 2001-74110 has been known. Therefore, in the case described above, a technique of replacing a geared motor with such a hypoid geared motor is used.

The “geared motor” is merely one component when, for example, the entire conveyance system is considered. Therefore, one of its great advantages is that the specifications of the entire device can be changed only by replacing the component. In this regard, it can be said that the geared motor has been positioned merely as the “minimum unit component” in the system.

The geared motors are roughly classified into parallel axis type and orthogonal axis type. Because of the above-described background, the parallel axis type and the orthogonal axis type are conventionally almost fully separated from each other for fabrication as well as for sales in the actual conditions. For example, a motor including a parallel axis type spur pinion or helical pinion formed on a tip of its motor shaft is always used in combination with a parallel axis type gear box. Thus, there was not idea of using it as an orthogonal axis type motor.

### SUMMARY OF THE INVENTION

The present invention focuses attention on the potentially existing problems under the above-described background so as to solve the problem with an innovative idea. In view of the foregoing problems, various exemplary embodiments of this invention provide a hypoid geared motor allowing the use of a motor with a pinion, which should otherwise be used in combination with a parallel axis type gear box, as a motor of a geared motor having a hypoid gear set as well as the continuous use of the motor that is already in use as much as possible (without disposal thereof) at relocation or the like, for example, in an existing facility as described below.

In addition, various exemplary embodiments of this invention provide an efficient connection structure between a motor pinion and a hypoid pinion.

In order to achieve the above objects, a hypoid geared motor according to one of exemplary embodiments of the invention comprises: a motor having a motor shaft with a motor pinion formed on the motor shaft; a hypoid gear box having a hypoid pinion, the hypoid pinion being engageable with an outer circumference of the motor pinion at an end portion of a motor side thereof; and a friction clamp formed on the end potion, the friction clamp connecting the hypoid pinion and the motor pinion by friction clamping.

In the exemplary embodiments of the present invention, a “motor with a pinion” including a pinion formed on a tip of its motor shaft, which was never conventionally considered to be used as a motor of a hypoid geared motor, can be used as a motor of a hypoid geared motor. As a result, the present invention paves the way to more effectively use a large amount of motors with pinions which are stocked at a manufacturer, or motors with pinions which are actually working at each factory or the like (described below).

In the exemplary embodiments of the present invention, as a specific structure for realizing it, a friction clamp is formed on an end of the hypoid pinion on the motor side. The friction clamp connects the hypoid pinion and the motor pinion by friction clamping so that the motor pinion on the motor side and the hypoid pinion on the gear box side are directly connected with each other by friction clamping.

Since the connection is achieved by the friction clamping, the two members are connected while being perfectly in close contact with each other and secured. As a result, there is no possibility of generating an impact noise at the joint portion even if the amount of an axial load, which is inevitably generated in view of the nature of the hypoid pinion, varies or a direction in which the axial load is applied is reversed. Therefore, it is not fundamentally necessary to add a bonding step for assembly and fabrication. Moreover, detachment is also possible. This advantageous point will also be described below.

According to various exemplary embodiments of the present invention, a motor with a pinion, which is frequently used at an existing factory or the like (or a large number thereof are present at the market of geared motors) can still be used as a motor of a hypoid geared motor and can freely be detached at any time. Therefore, a compact hypoid geared motor, which prevents the waste and ensures a high degree of freedom of design or a high degree of freedom of design change, can be obtained.

### BRIEF DESCRIPTION OF THE DRAWINGS

Various exemplary embodiments of the present invention will be described in detail with reference to the accompanying drawings, wherein:

FIG. 1 is a front sectional view of a hypoid geared motor according to an exemplary embodiment of the present invention;

FIG. 2 is a side view taken along the arrow II-II of a casing (gear box) of a hypoid reduction gear of the hypoid geared motor shown in FIG. 1;

FIG. 3 is an enlarged view of the vicinity of a clamp ring of the hypoid geared motor;

FIG. 4 is an enlarged view of a principal part of FIG. 3;

FIG. 5 is a partially exploded perspective view of the vicinity of an end of a hypoid pinion according to another exemplary embodiment of the present invention; and

FIG. 6 is a cross-sectional view showing a conventional example of the configuration of a hypoid geared motor.

### DETAILED DESCRIPTION OF THE PREFERRED EMBODIMENT

Various exemplary embodiments of this invention will be hereinafter described in detail with reference to the drawings.

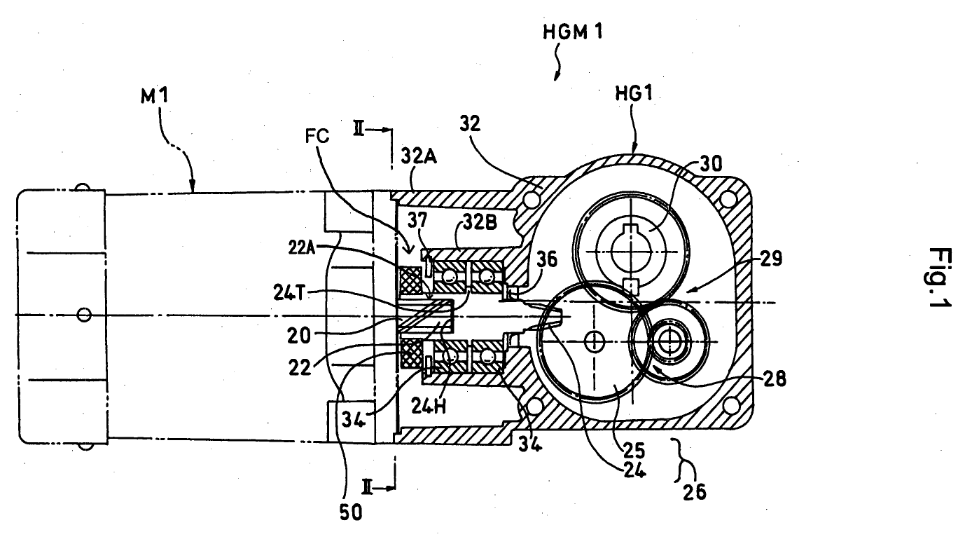

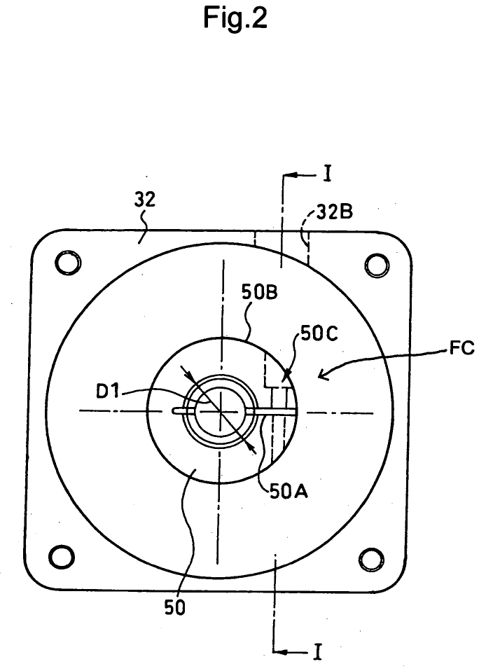

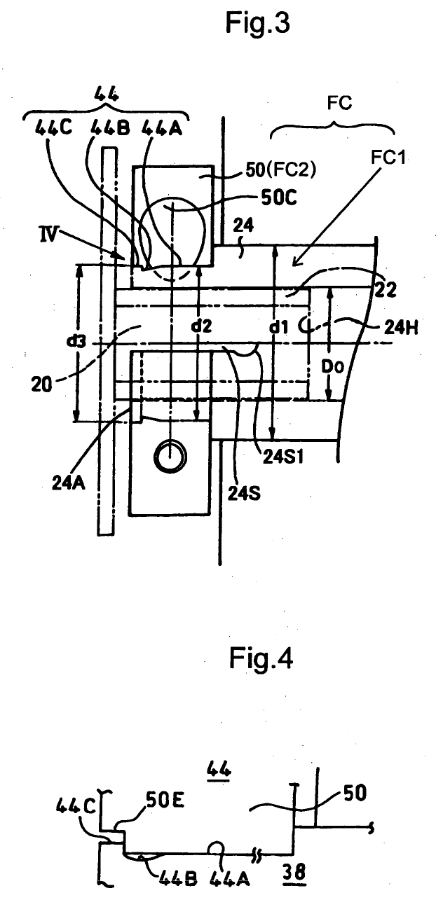

FIG. 1 is a front sectional view of a hypoid geared motor according to an exemplary embodiment of the present invention, FIG. 2 is a sectional view of an end face of a reduction gear viewed from the motor side (corresponding to a view taken along the arrow II-II in FIG. 1), and FIG. 3 is an enlarged sectional view of the vicinity of a friction clamping portion.

A hypoid geared motor HGM1 is constituted by integrally connecting a motor M1 and a hypoid reduction gear HG1 with each other. The motor M1 includes a helical pinion (motor pinion) 22 which is integrally formed on an end of its motor shaft 20. Specifically, this exemplary embodiment corresponds to an example where the present invention is applied to the motor M1 including a pinion that does not engage with a hypoid gear (25) to form a novel hypoid geared motor HGM1.

A hypoid reduction gear HG1 includes a hypoid pinion 24 connected to the helical pinion 22 formed on the motor shaft 20 and the hypoid gear 25 engaging with the hypoid pinion 24. A hypoid reduction mechanism 26 is constituted by the hypoid pinion 24 and the hypoid gear 25. At the latter stage of the hypoid gear mechanism 26, a first parallel axis gear reduction mechanism 28 and a second parallel axis gear reduction mechanism 29 are located so as to obtain the rotation of the hypoid gear 25 from an output shaft 30 after the speed of rotation is further reduced.

On the motor M1 side of a casing (gear box) 32 of the hypoid reduction gear HG1, cylindrical parts 32A and 32B forming a double-layered structure are formed to extend in the axial direction. Bearings 34 are located inside the inner cylindrical part 32B so as to rotatably support the hypoid pinion 24. The reference numerals 36 and 37 denote snap rings for regulating the axial movement of the bearings 34 and the hypoid pinion 24. A ring-shaped projection 24T is formed on the hypoid pinion 24 so as to regulate the axial position of the hypoid pinion 24 between the bearings 34.

As shown in FIGS. 3 and 4 in an enlarged manner, the hypoid pinion 24 includes, on its end face 24A on the motor M1 side, a concave 24H into which the helical pinion 22 formed on the motor shaft 20 is inserted.

The hypoid pinion 24 includes a slit 24S extending from an outer circumferential side of the concave 24H to its inner circumferential side along the axial direction. By variation of a gap of the slit 24S, an inner diameter Do of the concave 24H of the hypoid pinion 24 can also vary. An end 24S1 of the slit 24S is rounded so as to prevent stress concentration.

A friction clamp FC is formed on an end of the hypoid pinion 24 on the motor side. The friction clamp FC connects the hypoid pinion 24 and the helical pinion 22 by friction clamping. The friction clamp FC comprises an engaging portion FC1 and a clamp member FC2 (a clamp ring 50). The engaging portion FC1 is formed on the end of the hypoid pinion 24 on the motor side, and has the concave 24H into which helical pinion 22 is inserted. The clamp member FC2 (a clamp ring 50) clamps the engaging portion FC1 from outside of the concave 24H in a radial direction with the helical pinion 22 inserted in the concave 24H.

On the outer circumference of the concave 24H of the hypoid pinion 24, a ring-shaped step portion 44 is formed in a circumferential direction. The step portion 44 comprises a smooth portion 44A, a boundary portion 44B, and a terminal portion 44C. The bottom of the smooth portion 44A is processed to have a smaller outer diameter d2 than an outer diameter d1 of the hypoid pinion 24. The boundary portion 44B forms a slight cut in a continuous manner from the smooth portion 44A. The terminal portion 44C is processed to rise from the boundary portion 44B to have a slightly larger outer diameter d3 than the outer diameter d2 of the smooth portion 44A. Specifically, the relation: d2<d3<d1 is established.

The clamp ring 50 constituting the clamp member FC2 of the friction clamp FC is placed so as to cover the step portion 44. However, a step is formed in a portion 50E of the clamp ring 50 corresponding to the terminal portion 44C, and therefore, the clamp ring 50 is not in contact with the terminal portion 44C. As a result, the clamp ring 50 and the hypoid pinion 24 can be in contact with each other mainly on the smooth portion 44A. The boundary portion 44B is not necessarily a cut as a shape. However, since it is difficult to process the boundary portion 44B so that the outer diameter d3 is slightly larger than the outer diameter d2 in practice, it is preferred that the boundary portion 44B have a notch shape so as to ease such difficulty.

As shown in FIG. 2, the clamp ring 50 has a slit 50A whose gap can be reduced in the circumferential direction and has a C-shape as a whole. The clamp ring 50 has a notch 50C formed in a part of its outer circumference 50B, into which a bolt (not shown) is screwed. The screwed bolt allows the slit 50A to be fastened. By fastening the slit 50A, a state is formed, where the outer circumference 22A of the helical pinion 22 is clamped from the outside of the concave 24H of the hypoid pinion 24 in a radial direction. An elongated hole 32B having an oval cross section is formed through the casing 32 so as to allow the bolt to be screwed therein.

An inner diameter D1 of the clamp ring 50 in its free state (in a state where it is not clamped by screwing the bolt) is smaller than the outer diameter d1 of the hypoid pinion 24 (D1<d1). Furthermore, the inner diameter D1 is set smaller than the outer diameter d3 of the terminal portion 44C of the step portion 44 (D1<d3).

The functions of the hypoid geared motor HGM1 according to this exemplary embodiment will now be described.

When the hypoid pinion 24 is connected to the helical pinion 22 on the motor shaft 20 of the motor M1, the helical pinion 22 is first inserted into the concave 24H of the hypoid pinion 24. It is preferred that the clamp ring 50 is engaged with the step portion 44 from the beginning.

Since the inner diameter D1 of the clamp ring 50 in its free state (in a state where it is not clamped by screwing the bolt) is smaller than the outer diameter d1 of the hypoid pinion 24, the clamp ring 50 is easily positioned at the step portion 44. Since the relation, the inner diameter D1<the outer diameter d3, is established, the clamp ring 50 suitable for the hypoid pinion 24 can be prepared in advance so as to be attached to the hypoid reduction gear HG1 side. Therefore, the attachment operation of the clamp ring 50 can be omitted at the place of installation (at a factory or the like). In addition, it is possible to always attach the most suitable clamp ring 50. Moreover, since the relation, D1<D3, is established, the clamp ring 50 can be prevented from coming off from the step portion 44 in the course of transport or the like even if the clamp ring 50 is attached in advance.

Since the inner diameter D1 of the clamp ring 50 is set smaller than the outer diameter d3 of the terminal portion 44C of the step portion 44, the clamp ring 50 is placed on the step portion 44 while the clamp ring 50 is being slightly expanded.

When the gap of the slit 50A of the clamp ring 50 is reduced by screwing the bolt (not shown) of the clamp ring 50, the outer circumference 22A of the helical pinion 22 is clamped from the outside of the concave 24H of the hypoid pinion 24 in a radial direction so as to frictionally clamp the helical pinion 22 and the hypoid pinion 24.

In the uses of this kind of the hypoid geared motor HGM1, the acceleration, the deceleration, and the stop of the rotation of the motor shaft 20 are frequently repeated in many cases. In the connection structure according to this embodiment, the motor shaft 20 and the hypoid pinion 24 are fully integrated in the axial direction as well as in the direction of rotation. Therefore, the function of the helical pinion 22 is completely blocked. As a result, there is no possibility that inconvenience, which generally exists at a joint or the like (for example, the generation of a clattering noise in its reverse rotation, the generation of back-lash, and the like), may occur. Moreover, there is no possibility that fretting may occur in a contact portion. Furthermore, detachment after assembly is easy.

In the nature of the present invention, the shape of the motor pinion is not particularly limited. For example, even if the motor pinion is any one of a spur pinion, a helical pinion, and a worm pinion, the present invention is applicable without any problems. Moreover, the present invention can be applicable even to a bevel pinion depending on a change in the shape of an engaging portion or the structure of the friction clamp. As the case where the present invention is applied to a motor including a bevel pinion, the upgrading of an orthogonal transformation mechanism from a bevel gear set to a hypoid gear set is conceived, when the driving at a lower noise or with a smaller vibration is required. Even in such a case, an existing motor with a bevel pinion can still be used.

Moreover, the present invention can be effectively applied even if the motor pinion is a hypoid pinion in some cases. For example, in the case where, for some reason, there arises the need of changing a reduction ratio of a dedicated hypoid geared motor including a hypoid pinion formed on a motor shaft which has been used up to then, the application of the present invention allows a hypoid geared motor having a desired reduction ratio to be obtained with the continuous use of the existing motor (with the hypoid pinion).

The basically unlimited shape of the pinion formed on the motor shaft side is also an advantage obtained by connecting the motor pinion and the hypoid pinion with each other by “friction clamping” according to the present invention.

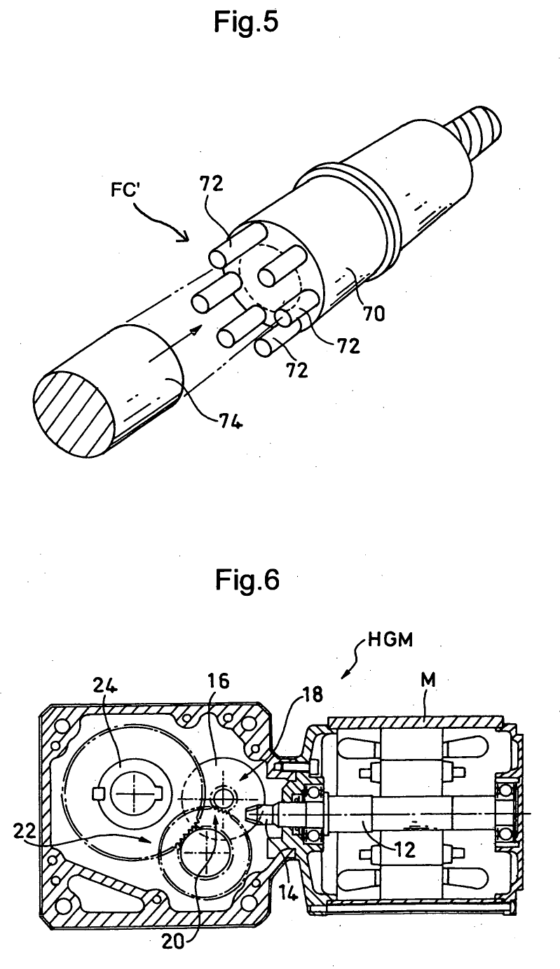

In the above-described exemplary embodiment, the concave 24H is formed on the end face of the hypoid pinion 24 on the motor M1 side so as to insert the tip of the motor shaft 20 therein. In the present invention, however, any structure of the engaging portion or the structure of the friction clamp may be used as long as it satisfies the conditions described above. For example, as shown in FIG. 5, an engaging portion of a friction clamp FC′ may have a plurality of axial projections 72 formed on an end of a hypoid pinion 70 on the motor (not shown) side along its outer circumference such that an end of a motor shaft 74 is inserted and placed in the midst of the plurality of projections 72 so as to be surrounded thereby. In this case, the plurality of projections 72 are clamped from the outside in the respective radial directions to frictionally clamp the hypoid pinion 70 and the end of the motor shaft 74.

The present invention can be used in various situations.

First, as already described above, for example, if there arises the need of changing a direction of rotation of an output shaft of an existing system using a gear pair mechanism with parallel axes to a direction at a right angle, an existing motor with a pinion can still be used as is even if a spur pinion, a helical pinion, or the like is formed on a motor shaft of the motor.

Even if the direction of rotation of the output shaft of the system is desired to be changed to be at a right angle, the motor itself is not particularly required to be replaced. Nevertheless, in conventional cases, a geared motor including a motor with a pinion that had been used up to then was replaced by a completely new hypoid geared motor. This requires new and large investment. In addition, there arises a problem of disposal of the motor with a pinion that has been used. The disposal of the motor with a pinion that can still be used results in the waste of resources. On the other hand, the storage of the motors for the future use imposes a heavy burden on the stock of products.

On the other hand, if the rotation of a motor is received by a gear engaging with a pinion formed on a motor shaft so as to then transmit the motive power to a hypoid pinion in order to make use of the existing motor with a pinion, not only the cost is increased but also the space efficiency is degraded because an intermediate stage is present.

In this regard, the present invention allows an existing motor with a pinion to be still used. Therefore, a great advantage can be obtained in the first situation where the present invention is applied.

As the second situation where the present invention is applied, the “conversion” of the motor with a pinion is conceivable. For example, a manufacturer of geared motors or a large factory has a large amount of stock of new general (parallel axis) motors with a pinion in many cases. If the present invention is applied in such a situation, a hypoid geared motor can be realized merely by supplying a hypoid gear box. As a result, the delivery date can be greatly advanced and the cost can be remarkably reduced in some cases as compared with the case where a fully new hypoid geared motor is supplied.

It is apparent that the industrial applicability of the present invention is not limited to the above-described applicable situations. The present invention can be effectively used in various situations where a motor with a pinion (which cannot be used without the application of the present invention) is used as a motor of a hypoid geared motor in a broader way.

The disclosure of Japanese Patent Application No. 2003-418588 filed Dec. 16, 2003 and Japanese Patent Application No. 2004-030467 filed Feb. 6, 2004 including specifications, drawings and claims are incorporated herein by reference in their entireties.

1. A hypoid geared motor comprising:
a motor having a motor shaft with a motor pinion formed on the motor shaft;
a hypoid gear box having a hypoid pinion, the hypoid pinion being engageable with an outer circumference of the motor pinion at an end portion of a motor side thereof; and
a friction clamp formed on the end potion, the friction clamp connecting the hypoid pinion and the motor pinion by friction clamping.

2. The hypoid geared motor according to claim 1, wherein,
the friction clamp comprises:
an engaging portion disposed on the end portion, the engaging portion having a concave into which the motor pinion is inserted; and
a clamp member for clamping the engaging portion from outside of the concave in a radial direction with the motor pinion inserted in the concave.

3. The hypoid geared motor according to claim 1, wherein,
the friction clamp comprises:
an engaging portion formed on the end of the hypoid pinion on the motor side, the engaging portion having a plurality of axial projections; and
a clamp member for clamping the engaging portion from outside of the plurality of projections in the respective radial directions with the motor pinion inserted in the midst of the plurality of projections.

4. A connection structure between a motor pinion and a hypoid pinion, wherein:
the motor pinion is formed on a motor shaft of a motor;
the hypoid pinion is housed within a gear box and engageable with an outer circumference of the motor pinion at an end portion of a motor side thereof; and
the connection structure comprises a friction clamp formed on the end portion, the friction clamp connecting the hypoid pinion and the motor pinion by friction clamping.
